(19) United States
(12) Patent Application Publication
(10) Pub. No.: US 2019/0097350 A1
(43) Pub. Date: Mar. 28, 2019

(54) ELASTOMERIC, ELECTRICAL INSULATOR WITH ONE OR MORE ADDITIONAL PROTECTIVE PROPERTIES

(71) Applicant: IDEAL Industries, Inc., Sycamore, IL (US)

(72) Inventors: Douglas A. Sanford, Naperville, IL (US); David G. Kotowski, Geneva, IL (US); Joseph Saganowich, Cary, NC (US); Alan E. Zantout, Sycamore, IL (US); Michael Weiby, Bartlett, IL (US); Sam Peterson, Sycamore, IL (US); Andrew Meyer, Yorkville, IL (US)

(21) Appl. No.: 16/139,476

(22) Filed: Sep. 24, 2018

Related U.S. Application Data
(60) Provisional application No. 62/563,293, filed on Sep. 26, 2017.

(51) Int. Cl. H01R 13/52

(52) U.S. Cl. CPC H01R 13/5213

(57) ABSTRACT

An apparatus for insulating electrical terminals of an electrical connection device, such as a light switch or outlet. In an example, the electrical connection device has a first outer circumference, while the apparatus has a second outer circumference that is less than the first outer circumference. The apparatus is to be fitted around the electrical connection device and be maintained thereon by an elastic force of the apparatus.

### RELATED APPLICATION INFORMATION

This application claims the benefit of U.S. Application No. 62/563,293, filed on Sep. 26, 2017, the disclosure of which is incorporated herein by reference in its entirety.

### FIELD OF THE DISCLOSURE

The present description relates generally to elastomeric, electrical insulators.

### BACKGROUND OF RELATED ART

Electrical connection devices, such as light switches, outlets (collectively “outlet boxes”), splice connectors, and the like, often have an electrical connection component, such as a screw terminal, a coil spring, etc., to which one or more electrical wires are to be connected. Electricians sometimes choose to wrap such devices with a heat-shrink material, electrical tape, and/or a band to prevent unwanted contact with the wires and/or the electrical connection components as described, by way of example, in U.S. Pat. Nos. 6,478,606, 6,664,477, and 8,803,007.

### SUMMARY

The following generally describes insulators for use with electrical connection devices as well as methods for making the same. The described insulators are manufactured to be resilient, electrically insulating, and to have additional protective properties, e.g., to be flame retarding and/or UV inhibiting. In a described, non-limiting example, an insulator is in the form of a band and has a thickness that insulates a user from an electrical current, a width dimensioned to cover the electrical connection component(s) associated with the electrical connection device, and a length and an inside opening width dimensioned to provide an elastic force upon the electrical connection device to maintain the insulator in position upon, and to prevent breakage and springing from, the electrical connection device.

### BRIEF DESCRIPTION OF THE DRAWINGS

FIG. 1 is a perspective view of an example insulator in the form of an elastomeric insulation band.

FIG. 2 is a perspective view of an example insulator in the form of an elastomeric insulation band with a pull tab.

FIG. 3 is a perspective view of an example insulator in the form of an elastomeric insulation band.

FIG. 4 is a perspective view of an example insulator in the form of an elastomeric insulation band with a pull tab.

FIG. 5 is a diagram illustrating an example use of an insulator.

FIG. 6 is a perspective view of an example insulator in the form of a strip that is formable into a band.

FIG. 7 is a perspective view of the insulator of FIG. 6 disposed on an electrical connection device in the form of an outlet.

FIG. 8 is a side view of an example insulator in the form of a strip that is formable into a band.

FIG. 9 is perspective view of an example insulator in the form of a cup disposed on an electrical connection device in the form of an outlet.

FIG. 10 is perspective view of an example insulator in the form of a band disposed on an electrical connection device in the form of a splice connector.

FIG. 11 is perspective view of an example insulator in the form of a cup disposed on an electrical connection device in the form of a splice connector.

### DETAILED DESCRIPTION

The following description of example methods and apparatuses is not intended to limit the scope of the subject insulators to the precise form or forms detailed herein. Instead the following description is intended to be illustrative so that others may follow its teachings.

The present application discloses example insulators for use with electrical connection devices. The insulators described herein are elastomeric, such that they can be stretched to fit around the electrical connection device. The insulators are then held in place by the contracting force of the elastomer, without the need for additional adhesives. Accordingly, the insulation bands can be easily installed on or removed from electrical connection devices, and may be reused on a further electrical connection device (e.g., using the same insulation band when replacing a light switch).

As one example, an insulator may be in the form of a band and the band may be formed from an extruded elastomer. The elastomer may be formed from one or more separate materials, each contributing different properties to the insulator. For instance, silicone may provide elasticity, insulation, and thermal resistance, among other properties. One or more compounds (also referred to herein as “fillers”) may be added to the silicone to enhance its properties, or provide new beneficial properties to the resulting material. For example, in humid environments, it may be preferred to have a material with low water absorption; one or more fillers may be introduced to the silicone to enhance its water resistance. Other fillers may be added to produce a material that is flame retardant, ultra violet (UV) resistant, increase the material's tensile strength, increase the dielectric strength of the material, or increase the operating temperature range of the material, among other properties.

In some examples, the insulator is coated with one or more materials that enhance existing properties of the insulator and/or provide additional properties to the insulator. For example, a liquid material may be sprayed onto the insulator to enhance the insulator's resistance to UV light, thereby extending the life of the insulator. Other coatings may provide other properties described hereinafter.

In some instances, the compound or combination of compounds used to form an insulator are selected to comply with local regulations, standards requirements, and/or environmental regulations. Additionally, a given insulator may be designed to be fitted with an electrical connection of a particular shape and size. Such an insulator will generally have dimensions that are smaller than the electrical connection device, so that the insulator may be stretched around the exterior surface of the electrical connection device and tightly held in place when released (i.e., by the “elastic force” of the stretched material of which the insulator is comprised).

Some insulators are extruded or otherwise manufactured to form one or more features on the insulator e.g., to assist with the installation and removal of the insulator from electrical connection devices. For example, a pull tab may be provided on the insulator, which can be gripped and pulled to stretch the insulator for removal or installation purposes. An insulator may also be extruded to introduce a feature to assist in removal or installation purposes; for example, the insulator may be provided with a rigid or semi-rigid portion, e.g., a portion that is not as resilient as the remainder of the insulator, that will generally maintain its shape and which is arranged to protrude outward even when the insulator is released upon an electrical connection device to thereby provide a gap between the insulator and the electrical connection device within which an electrician can place a finger, place additional material, such as a water resistant material, an anti-oxidizing material, a fire retarding material, an electrically insulating material, etc.

Although specific examples are described herein, it is to be understood that any combination of materials and/or manufacturing processes may be used to form the insulators hereinafter described.

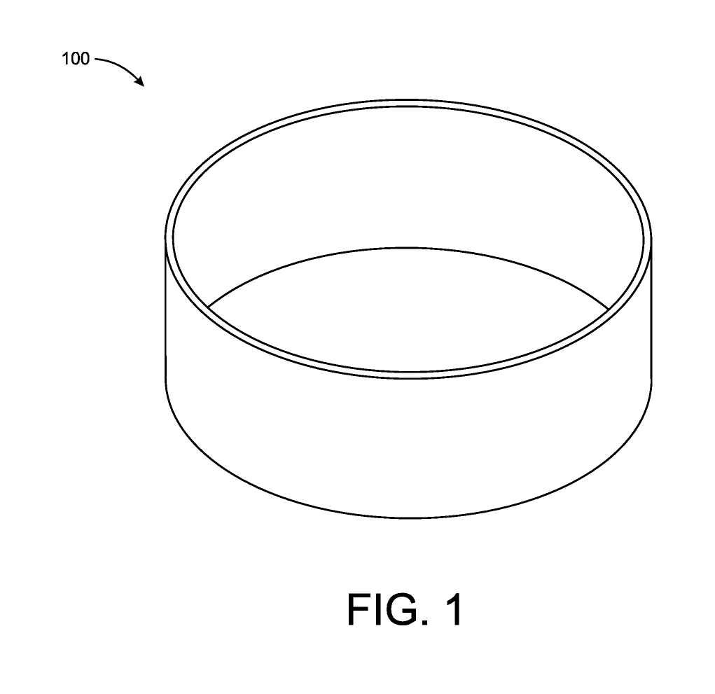

FIGS. 1-4 illustrate different insulators in the form of elastomeric insulation bands. Although specific shapes and configurations are shown, any insulator described herein is intended to be capable of being stretched and/or contracted to temporarily modify its shape and dimensions. For example, an insulator may have a “rest” radius which can be modified by subjecting the insulator to a force (e.g., an electrician stretching an insulating band for placement around an electrical connection device). It will be understood that FIGS. 1-4 show the resting shape of the insulating, elastomeric bands.

FIG. 1 is a perspective view of an example elastomeric insulation band 100. In this example, the elastomeric insulation band 100 is a continuous circular ring. The elastomeric insulation band 100 may be initially formed from a long tube of extruded material, which is then cut at periodic lengths to produce the elastomeric insulation band 100.

Some insulators, including elastomeric insulation band 100, may be “continuous” in that there are no seams or joints within the insulator. Such continuity may be achieved through extrusion or injection molding, among other manufacturing techniques.

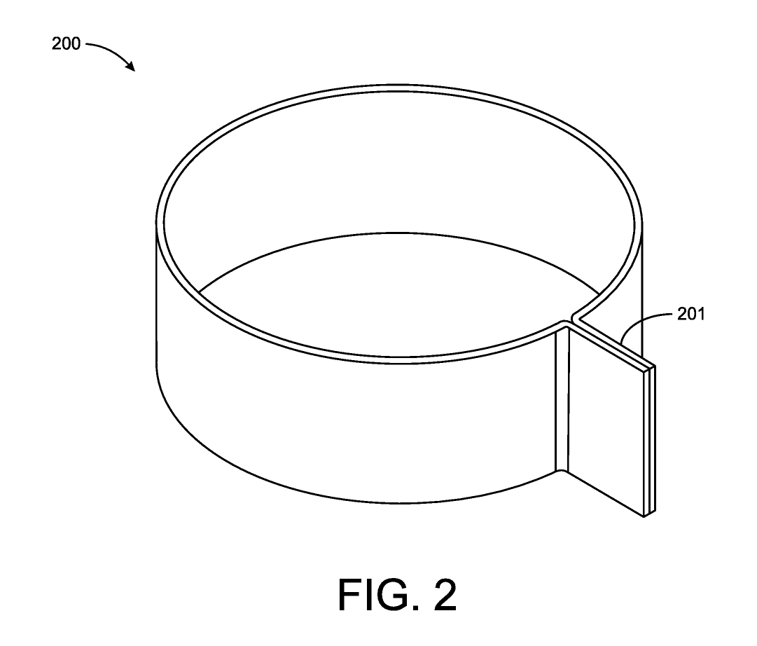

FIG. 2 is a perspective view of an example elastomeric insulation band 200 with a pull tab 201. In this example, the elastomeric insulation band 200 is initially formed as a flat rectangular strip of material (e.g., synthetic rubber, thermoplastic elastomer, etc.). Opposite ends of the strip are then brought together and joined, via curing or adhesive, to form a closed loop.

The pull tab 201 may serve as a handle for a user or electrician to grip onto, to assist in the installation or removal of the elastomeric insulation band 200. The pull tab 201 may include other features thereon and/or therethrough, such as a roughened texture to enhance grip or a hole extending through the pull tab 201 for hanging the elastomeric insulation band 200 on a ring (e.g., on an electrician's tool belt). In some instances, a grommet or the like, preferably constructed from a non-conductive material, can be placed into a hole formed through the pull tab 201 to provide further mechanical stability to the hole. It will also be appreciated that insulation band may be molded with a pull tab.

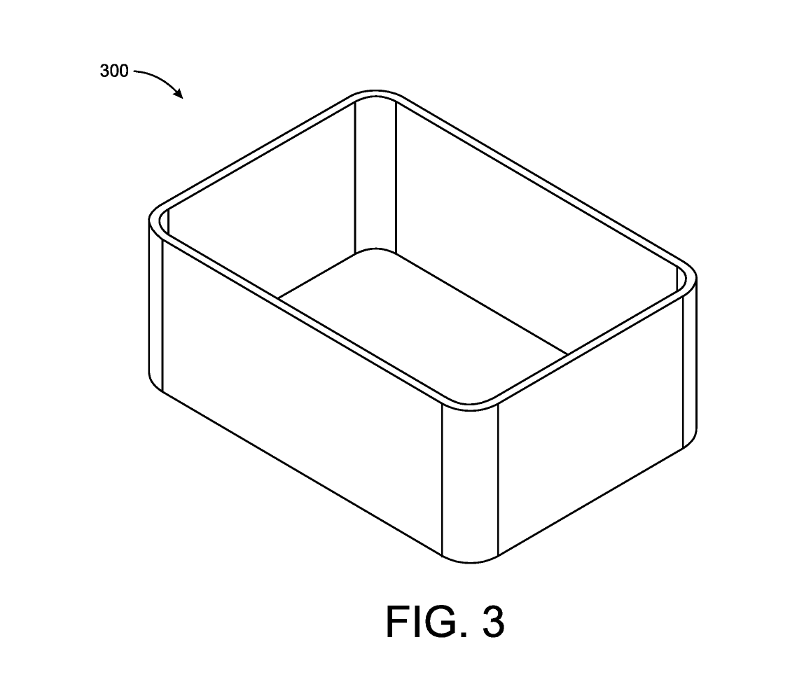

FIG. 3 is a perspective view of an example elastomeric insulation band 300. In this example, the elastomeric insulation band 300 is a continuous, generally rectangular shaped loop. The elastomeric insulation band 300 may be initially formed from a long extruded rectangular prism, which is cut into separate bands. Alternatively, the elastomeric insulation band 300 may be formed from injection molding, or curing of a synthetic rubber.

The elastomeric insulation band 300 may, in some instance, be substantially rectangular with beveled or curved edges. The shape of the elastomeric insulation band 300 is preferably substantially similar to the shape provided by exterior walls of an electrical connection device with which the elastomeric insulation band 300 is to be used. As will be understood, the interior dimensions of the elastomeric insulation band are intended to be smaller than the exterior dimensions of the electrical connection device with which the elastomeric band 300 is to be used to thereby ensure that the elastomeric insulation band 300 will snuggly extend around the electrical connection device when installed thereupon.

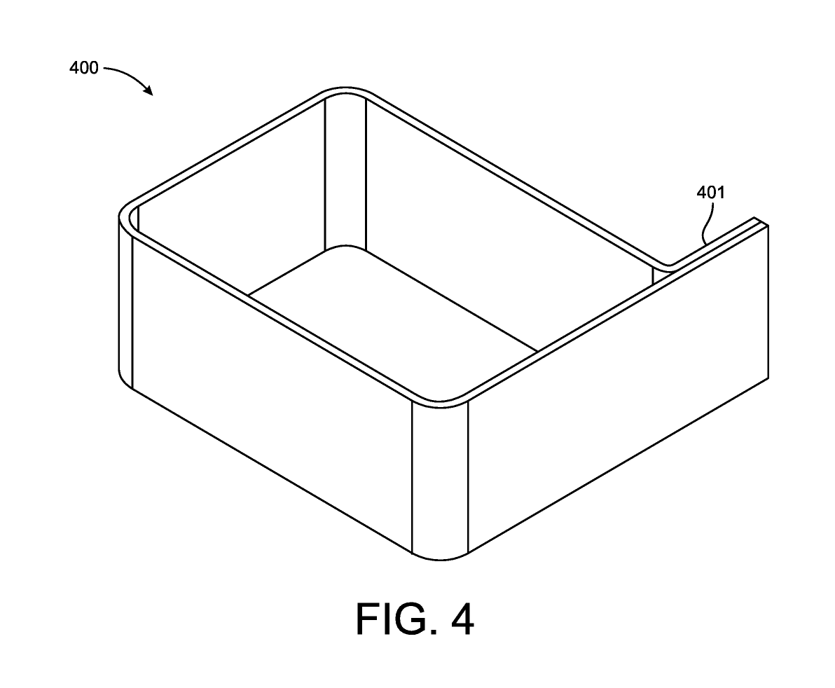

FIG. 4 is a perspective view of an example elastomeric insulation band 400 with a pull tab 401. In this example, the elastomeric insulation band 400 may be initially formed as a flat, elongated strip of material, which is fitted around or pressed into a substantially rectangular mold. Opposite ends of the strip may then be joined together to form a closed loop, with the joined portion serving as the pull tab 401. A variety of manufacturing techniques may be used to form the shape of the elastomeric insulation band 400, without departing from the scope of the present application. As before, the pull tab 401, which in this example is located at a corner area of the insulation band 400, may be provided with a hole, grommet, or the like for the purposes discussed above.

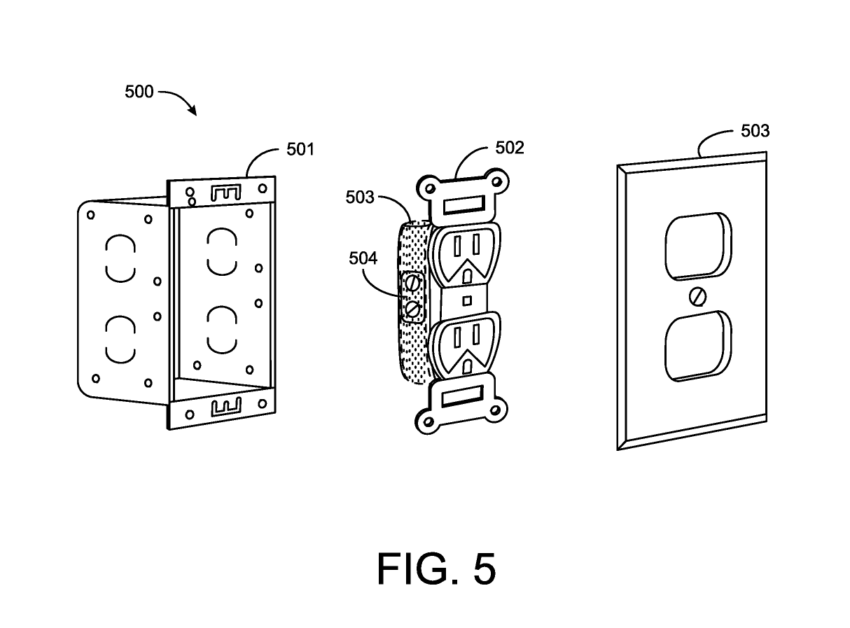

FIG. 5 is a diagram 500 illustrating a use of an elastomeric insulation band 503. In this example, it will be understood that insulation band 503 may be any insulator disclosed within this document. An example AC wall outlet includes a receptacle 501, an outlet 502, and a wall plate 503. The outlet 502 includes thereon screw terminals 504, which mechanically secure wiring for AC power to the outlet 502. When assembled, the outlet 502 is fitted partially within the receptacle 501; then, the wall plate 503 is secured to the front of the outlet 502.

As shown in FIG. 5, an example use of the elastomeric insulation band 503 involves fitting the band around the exterior side wall surfaces of the rear portion of the outlet 502, covering the screw terminals 504. In this manner, the risk of shorting the screw terminals when handling the outlet 502 is significantly reduced.

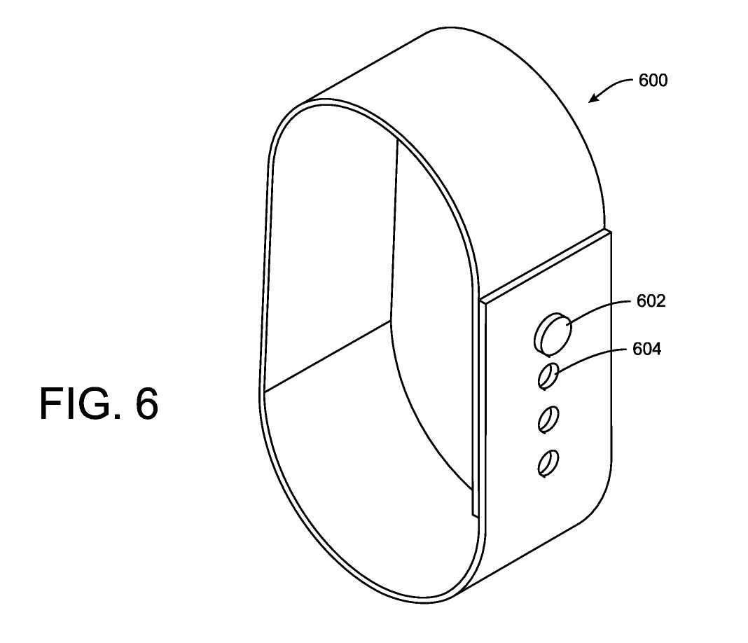

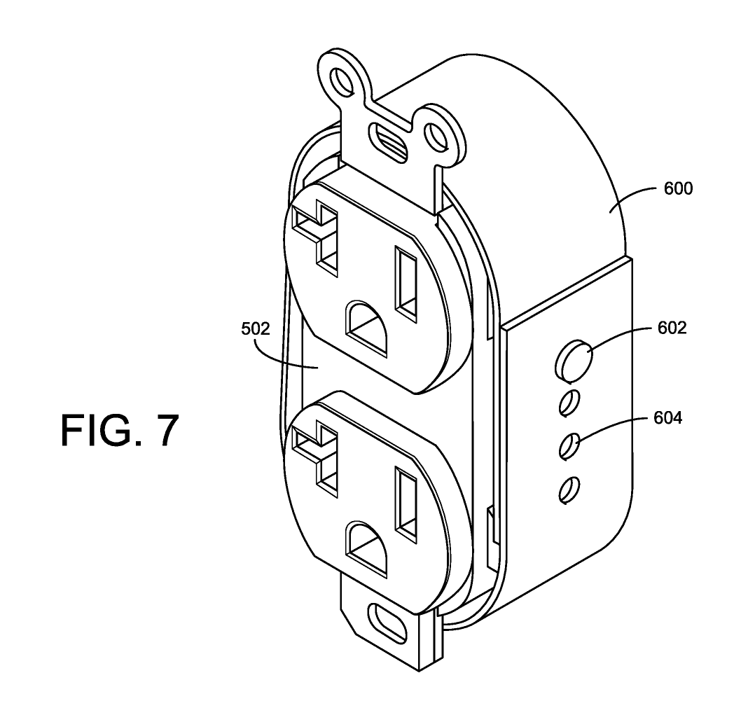

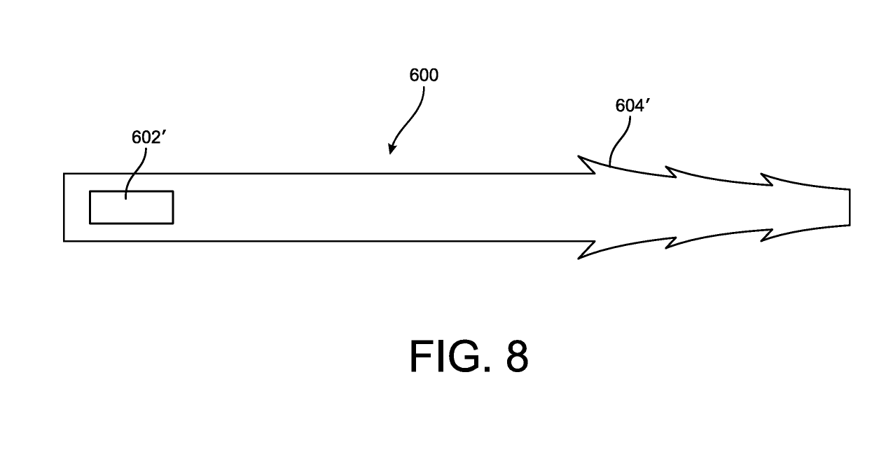

FIGS. 6 and 7 illustrate an insulator 600 in the exemplary form of a strip of resilient material that is provided with a locking feature that is comprised of cooperating locking elements 602 and 604 that, when engaged, function to turn the strip of resilient material into a band for use as described above. As will be appreciated, the locking elements 602 and 604 can be engaged to form the insulator 600 into a band prior to the insulator 600 being placed upon an electrical connection device, e.g., outlet 502. Likewise, the locking elements 602 and 604 can be engaged to form the insulator 600 into a band after the insulator 600 is stretched around the surface of the electrical connection device that is to be protected. To provide for some degree of adjustability, the locking feature can be provided with plural elements 602 and/or plural elements 604. While illustrated as a protrusion (having an larger sized head portion) that is intended to be releasably positioned within a one of plural apertures, it will be appreciated that the locking feature can use hook and loop fastening elements, e.g., “VELCRO,” use an adhesive, use cable tie like fastening elements, such as illustrated in FIG. 8 or as disclosed in U.S. Pat. Nos. 4,532,679 and 9,682,806, and the like without limitation.

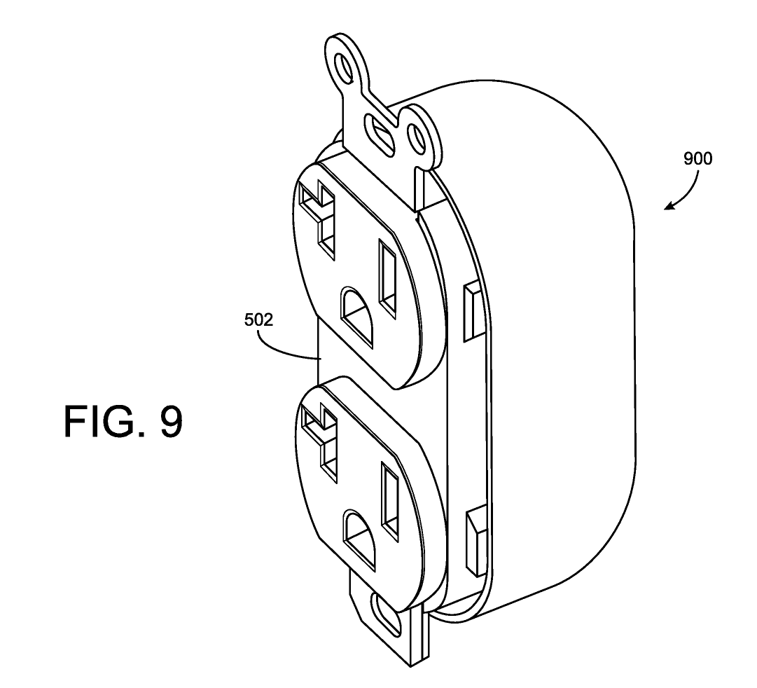

While the foregoing examples provide an insulator in the form of a band, in a further example, the insulator may have a cap or cup-like shape as illustrated in FIG. 9. In this example, the insulator 900 is intended to cover not only the sides of the electrical connection device, e.g., outlet 502, but to also cover the back side of the electrical connector device. While illustrated as being formed as a single, integral component, it will be appreciated that this form of the insulator 900 may be constructed from multiple components that are mated together as discussed above. In some instances, the insulator 900, for example the portion intended to cover the back side of the electrical connector device, may be provided with one or more openings and/or one or more predefined areas that may be punctured or the like to form an opening for use in directing a wire through the insulator 900 towards the electrical connection device.

In some instances, an insulator may be formed to provide one or more dimples or the like for use in holding a desired material, in particular, at a location over one or more electrical connection components, such as screw terminals 504, of the electrical connector device. Such dimples may be provided to the insulator by being molded into the insulator, by being formed in the insulator via use of heat or pressure, by using a material with a different degree of elasticity as compared to surrounding areas of the insulator, by varying the thickness of the material from which the insulator is constructed, or the like. The dimples may be formed so as to be visible when the insulator is “at rest,” e.g., the dimples would be seen to extend outwardly from the insulator, or may be formed so as to become visible when material is positioned under the dimple with the insulator otherwise being installed on the electrical connector device. Thus, it will be appreciated that a dimple area on an insulator may be a portion of the insulator that differs from surrounding portions of the insulator by being more rigid or more elastic relative thereto without limitation. When the insulator is positioned upon an electrical connector device, the dimple provides a means for a user to position one or more of a water resistant material, an anti-oxidizing material, a fire retarding material, an electrically insulating material, or other material as desired for any given purpose, between the insulator and an electrical connection components.

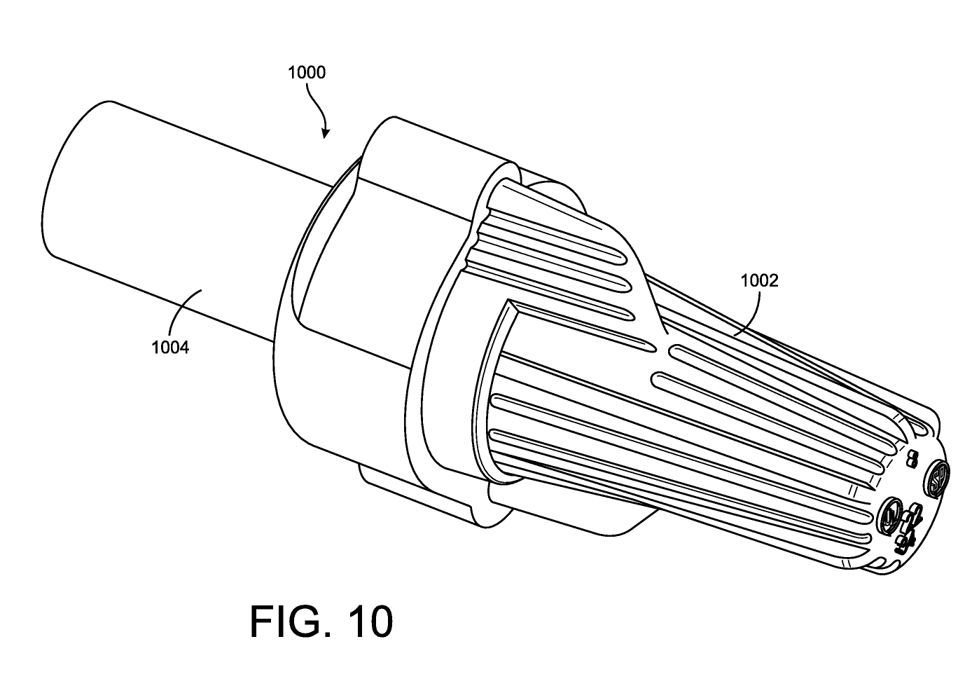

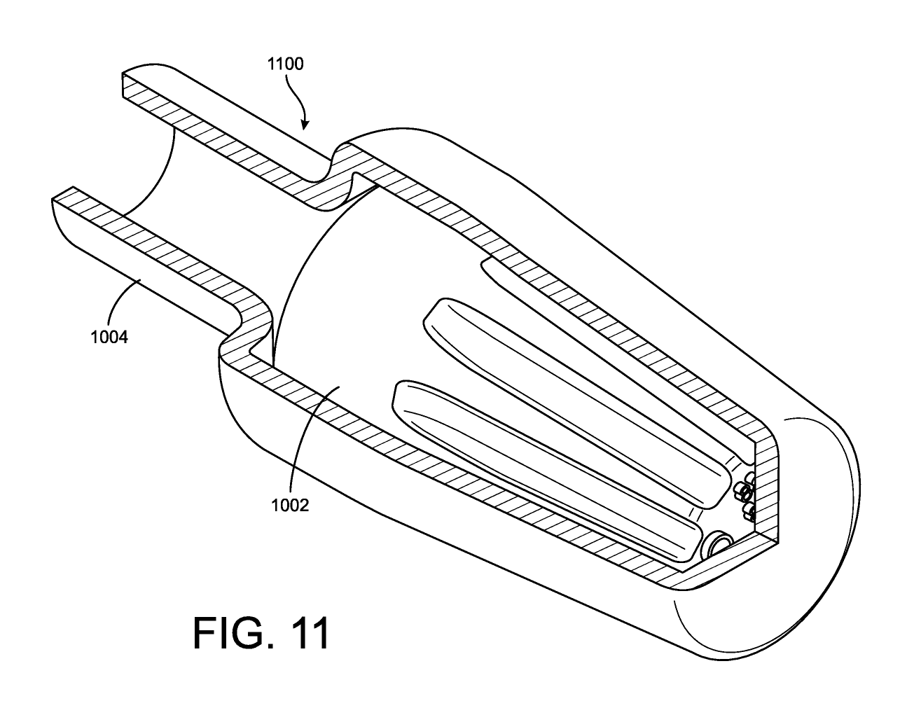

As further shown in FIGS. 10 and 11, the subject insulator may also be sized and arranged to be snuggly fit over electrical connection devices beyond the illustrated outlet 502. For example, the insulator, which may be in the form of a band 1000 or in the form of a cup 1100, may be sized and arranged to cover, in whole or in part, a housing 10002 of a splice connector while providing an elastic seal 1004 over the opening of the housing 1002 into which wires are to be inserted. In preferred embodiments, the elastic seal 1004 is also intended to be tightly held in place upon the wires that are inserted into the splice connector when the insulator is released thereupon. In some instances, the elastic seal 1004 may be provided with one or more predefined areas that may be punctured or the like to form an opening for use in directing a wire through the insulator towards the opening of the splice connector.

As noted previously, elastomeric insulators of the present disclosure are to be formed from a material or combination of materials (hereinafter “material”) that possess one or more desirable properties, including electrical properties, thermal properties, mechanical properties, and/or resistance to environmental conditions, among other properties. For example, a material may have a particular amount of resistivity and/or dielectric strength (e.g., per unit thickness) to meet a given application. A material may also be adapted to withstand a range of temperatures without significantly affecting its insulating properties or longevity. The materials will have the tensile strength to allow the insulator to tightly grip an electrical connection device with which the insulator it to be used.

In some instances, a material may be resistant to ultraviolet light degradation. Such a material may be preferred in environments where the elastomeric insulation band is exposed to sunlight. In further instances, the material may be provided with chemicals to make the material glow in the dark, illuminate under certain lighting conditions, etc.

The material may also be flame resistant or flame retardant, which reduces the chance of the elastomeric insulator catching on fire. As one example, a flame retardant additive is added to synthetic rubber before or during the curing process, thereby forming a flame resistant material.

Other materials may resist degradation from other environmental conditions. Certain materials and/or additives may reduce water absorption, which might be preferred in humid or wet environments. A given material or additive may be oxidation resistant as well.

In forming an elastomeric insulator, selecting the material or combination of materials may depend on a variety of factors, including the environmental conditions expected, the cost of materials and manufacturing, municipal codes, and/or federal regulations, among other factors. Compliance with some existing standards—such as UL 224 (standard for safety extruded insulating tubing), UL 510 (standard for polyvinyl chloride, polyethylene and rubber insulating tape), and UL 94 (standard for tests for flammability of plastic materials for part sin devices and appliance)—may be considered. As technology advances, additional standards may also be developed and considered when manufacturing a given elastomeric insulator.

Some example materials which may be used in forming an elastomeric insulator of the present disclosure include: ethylene propylene (EPDM), polysiloxane (silicone), nitrile, polychloroprene (e.g., Neoprene), styrene butadiene, fluorocarbon, hydrogenated nitrile, isobutylene isoprene, fuorosilicone, urethane, polyisoprene, synthetic polyisoprene, thermoplastic insulators (TPEs), and/or other materials.

Each of these materials may have respective advantages and disadvantages. For example, one material may have excellent tensile strength, but naturally poor flame resistance. Others may have great flame resistance and electrical insulation, but at a high cost. Given the variety of potential applications for an elastomeric insulator of the present disclosure, the material or combination of materials used may depend on a desired property or combination of properties.

In manufacturing the elastomeric insulator, a variety of processes may be used, which may depend on the particular material(s) used to form the insulator. For example, forming a band from synthetic rubber may involve a combination of extruding synthetic rubber into a long tube, placing those tubes on mandrels, curing the rubber with heat, and slicing the cured rubber along the width of the tube into smaller bands.

For other materials, such as TPEs, either extrusion or injection molding may be used to form the insulator. For injection molding, TPE is heated, melted, and injected into a molding machine where it cools and solidifies in the shape of the mold. Unlike synthetic rubbers, forming insulators from TPE does not involve a curing stage, potentially reducing the manufacturing time and cost. TPE injection molding may be preferred in implementations where an elastomeric insulator has complex shapes or features, such as protrusions or pull tabs.

Although certain example methods and apparatuses have been described herein, the scope of coverage of this patent is not limited thereto. On the contrary, this patent covers all methods, apparatus, and articles of manufacture fairly falling within the scope of the appended claims either literally or under the doctrine of equivalents.

What is claimed is:

1. An article for insulating an electrical connection device, the article comprising:
a substantially elastic insulator manufactured of an electrically insulating material and a flame retarding material, the insulator having a thickness that insulates a user from an electrical current associated with the electrical connection device, a width dimensioned to cover at least a portion of the electrical connection device at which inadvertent contact with the electrical current is possible, and a length and an inside opening width dimensioned to encircle the at least a portion of the electrical connection device and provide an elastic force upon the electrical connection device to maintain the insulator in position upon, and to prevent breakage and springing from, the electrical connection device.

2. The article as recited in claim 1, wherein the substantially elastic insulator is in the form of a band.

3. The article as recited in claim 2, wherein the elastic insulator include complimentary locking elements for forming the band.

4. The article as recited in claim 1, wherein the elastic insulator is in the form of a cup.

5. The article as recited in claim 1, wherein the electrical connection device comprises a splice connector.

6. The article as recited in claim 1, wherein the electrical connector comprises an outlet box.

7. The article as recited in claim 1, wherein the insulator comprises a thermoplastic elastomer (TPE) material.

8. The article as recited in claim 1, wherein the insulator comprises a nitrile material.

9. The article as recited in claim 1, wherein the insulator comprises an ethylene propylene diene monomer (EPDM) rubber material.

10. The article as recited in claim 1, wherein the insulator comprises a silicone material.

11. The article as recited in claim 1, wherein the insulator is continuous and has a substantially circular shape when the insulator is in a resting state.

12. The article as recited in claim 1, wherein the insulator is continuous and has a substantially rectangular shape when the insulator band is in a resting state.

13. The article as recited in claim 1, wherein the insulator is formed with a pull tab and wherein the pull tab extends outwardly in a direction away from the inside opening of the insulator.

14. The article as recited in claim 13, wherein the pull tab has an opening formed therethrough.

15. The article as recited in claim 1, wherein the insulator includes a portion that provides a spacing between the insulator and the electrical connection device when the insulator band is maintained in position upon the electrical connection device.

16. The article as recited in claim 1, wherein the insulator comprises an ultraviolet (UV) inhibiting material.

17. The article as recited in claim 1, wherein the insulator comprises an oxidation resisting material.

18. The article as recited in claim 1, wherein the insulator comprises a water absorption resisting material.

19. An article for insulating an electrical connection, the article comprising:
a substantially elastic insulator manufactured of an electrically insulating material and an ultraviolet (UV) inhibiting material, the insulator having a thickness that insulates a user from an electrical current associated with the electrical connection device, a width dimensioned to cover at least a portion of the electrical connection device at which inadvertent contact with the electrical current is possible, and a length and an inside opening width dimensioned to encircle the at least a portion of the electrical connection device and provide an elastic force upon the electrical connection device to maintain the insulator in position upon, and to prevent breakage and springing from, the electrical connection device.

20. The article as recited in claim 19, wherein the insulator comprises a thermoplastic elastomer (TPE) material.

21. The article as recited in claim 19, wherein the insulator comprises a nitrile material.

22. The article as recited in claim 19, wherein the insulator comprises an ethylene propylene diene monomer (EPDM) rubber material.

23. The article as recited in claim 19, wherein the insulator comprises a silicone material.

24. The article as recited in claim 19, wherein the insulator is formed with a pull tab and wherein the pull tab extends outwardly in a direction away from the inside opening of the insulator.

25. The article as recited in claim 19, wherein the pull tab has an opening formed therethrough.
